(19) United States
(12) Patent Application Publication
(10) Pub. No.: US 2005/0207097 A1
(43) Pub. Date: Sep. 22, 2005

(54) Neutral-ground connector subassembly

(75) Inventor: Bruce Neace, Mascoutah, IL (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Cooper Technologies Company

(21) Appl. No.: 10/803,494

(22) Filed: Mar. 18, 2004

(51) Int. Cl. H01R 13/28

(52) U.S. Cl. 361/627; 361/641

(57) ABSTRACT

A socket assembly for mounting an electric meter. The assembly includes a neutral-ground connector subassembly comprising a base having opposing legs and a bottom defining a saddle for supporting at least one neutral conductor of a power line system, and a connector of electrically conductive material slidable on the base. A first screw is threaded through a first screw opening in the connector to a position in which the screw contacts a neutral conductor laid between the legs of the base. A second screw is threaded through a second screw opening in the connector to a position in which the screw contacts a socket assembly ground conductor.

### BACKGROUND OF THE INVENTION

This invention relates generally to electric meters for monitoring the consumption of electricity, and more particularly to components used in a meter box to connect the neutral conductors of a power line system and a grounding conductor for the meter box.

In conventional meter boxes used for residences, the electric meter is plugged into a socket assembly in the meter box. In a single-phase, 3-wire power system, for example, the socket assembly includes two connector subassemblies for connecting the electric power supply conductors to the socket assembly, two connector subassemblies for connecting the electric power load conductors to the socket assembly, and a separate connector subassembly mounted at a separate location in the meter box for connecting the neutral conductors from the power supply and from the facility (e.g., residence) being serviced. This connector subassembly typically comprises an elongate metal block secured (e.g., fastened) to the meter box. The block has a longitudinal bore extending lengthwise through the block from one end to the other, and a pair of neutral screws are threaded into screw holes which extend from the top of the block and intersect the longitudinal bore. The neutral screws are screwed down against neutral conductors placed in the longitudinal bore. The block also has a bore extending into the block from one side face of the block for receiving a grounding conductor to ground the meter box. A grounding screw is threaded in a bore of the block against the grounding conductor.

In another arrangement, a neutral-ground connector subassembly is secured to a support on the meter socket generally at the center of the socket. In one version of this arrangement, the connector subassembly comprises an elongate U-shaped base and a pair of dovetail caps slidable on the base, each cap having a neutral screw threaded down through a bore in the cap into contact with a neutral conductor laid in the U-shaped base. A separate U-shaped grounding lug is slidably attached to one leg of the base for receiving a meter box grounding conductor. A grounding screw is threaded through a screw hole in the grounding lug against the grounding conductor. This arrangement is expensive due to the need for a separate grounding lug. Further, the mechanical connection between the grounding lug and the base must be sufficient to provide a good electrical path. Also, the grounding lug projects laterally from the outside of one leg of the base and is closely surrounded by other components of the socket assembly, including high-voltage parts. As a result, manipulation of the grounding screw is inconvenient and caution must be used. In another version, the connector assembly comprises a J-shaped base and an L-shaped cap which is held in assembly with the base when the neutral screw(s) is threaded down against the neutral conductor(s). In this version, the grounding lug is extruded as an integral part of the leg of the J-shaped base, thus eliminating the problems associated with using a separate part. However, the grounding lug extends laterally from the leg of the base, so that manipulation of the grounding screw is still problematic.

There is a need, therefore, for an improved design for connecting the neutral and grounding conductors in a meter box installation.

### SUMMARY OF THE INVENTION

Among the several objects of this invention may be noted the provision of meter socket assembly having an improved neutral-ground connector subassembly; the provision of such a subassembly which connects the neutral conductors and the meter box grounding conductor at the same location in the meter socket assembly; the provision of such a subassembly which is compact to provide greater access for making the necessary electrical connections; the provision of such a subassembly which uses a minimum number of parts; the provision of such a subassembly which is safe to use and economical to manufacture; and the provision of such a subassembly which includes a unique neutral-ground connector.

In general, this invention relates to a socket assembly for mounting an electric meter in a meter box. The socket assembly comprises a plurality of power line connector subassemblies for connecting electric power conductors of a power line system to the socket assembly, a plurality of socket connectors for receiving mating connectors of the electric meter, and a neutral-ground connector subassembly. The neutral-ground connector subassembly comprises a base having a bottom for supporting at least one neutral conductor of the power line system, a neutral-ground connector, a first screw and a second screw. The neutral-ground connector comprises a body, a first screw opening through the body, a hole in the body for receiving a ground conductor of the socket assembly and a second screw opening intersecting the hole in the body. The body is engageable with the base to mount the body on the base in a position in which a first face of the body faces toward the bottom of the base and a second face of the body opposite the first face faces away from the bottom of the base. The first screw opening through the body extends from the first face of the body to the second face of the body. The first screw is threadable in the first screw opening to a position in which the screw is adapted to contact the at least one neutral conductor on the bottom of the base. The second screw is threadable in the second screw opening to a position in which the second screw is adapted to contact the ground conductor.

In another aspect, this invention relates to a neutral-ground body subassembly for use in a socket assembly for mounting an electric meter. The subassembly comprises a base having a bottom for supporting at least one neutral conductor of a power line system, a neutral-ground connector, a first screw and a second screw. The neutral-ground connector comprises a body of electrically-conductive material, a first screw opening through the body, a hole in the body for receiving a ground conductor of the socket assembly and a second screw opening intersecting the hole in the body. The body is engageable with the base to mount the body on the base in a position in which a first face of the body faces toward the bottom of the base and a second face of the body opposite the first face faces away from the bottom of the base. The first screw opening extends from the first face of the body to the second face of the body. The first screw is threadable in the first screw opening to a position in which the screw is adapted to contact the at least one neutral conductor on the bottom of the base. The second screw is threadable in the second screw opening to a position in which the second screw is adapted to contact the ground conductor.

In yet another aspect, this invention relates to a neutral-ground connector for use in a socket assembly for mounting an electric meter. The socket assembly includes a base having a bottom for supporting at least one neutral conductor of a power line system. The connector comprises a body of electrically conductive material, a first screw opening through the body, a hole in the body for receiving a ground conductor of the socket assembly, a second screw opening intersecting the hole in the body, a first screw and a second screw. The body is configured for engagement with the base to mount the body on the base in a position in which a first face of the body faces toward the bottom of the base and a second face opposite the first face faces away from the bottom of the base. The first screw opening extends from the first face of the body to the second face of the body. The first screw is threadable in the first screw opening to a position in which the screw is adapted to contact the at least one neutral conductor on the bottom of the base. The second screw is threadable in the second screw opening to a position in which the second screw is adapted to contact the ground conductor.

The present invention is also directed to the neutral-ground connector subassembly and the neutral-ground connector described above.

Other objects and features of the present invention will be in part apparent and in part pointed out hereinafter.

### BRIEF DESCRIPTION OF THE DRAWINGS

FIG. 1 is a perspective of a meter socket assembly in a meter box, the assembly including one embodiment of a neutral-ground conductor subassembly of the present invention;

FIG. 2 is a front elevation of the FIG. 1;

FIG. 3 is an enlarged section along line 3-3 of FIG. 2;

FIG. 4 is an enlarged section along line 4-4 of FIG. 2;

FIG. 5 is a perspective of one embodiment of a neutral-ground conductor subassembly of this invention;

FIG. 6 is a sectional view taken on lines 6-6 of FIG. 5 to show details of a base component of the subassembly, with connector components of the subassembly being removed for clarity;

FIG. 7 is a perspective of a second embodiment of a neutral-ground conductor subassembly of this invention;

FIG. 8 is a partial perspective of FIG. 7, viewed from a different angle; and

FIG. 9 is a right end elevation of the subassembly of FIGS. 7 and 8.

Corresponding parts are designated by corresponding reference numbers throughout the drawings.

### DETAILED DESCRIPTION

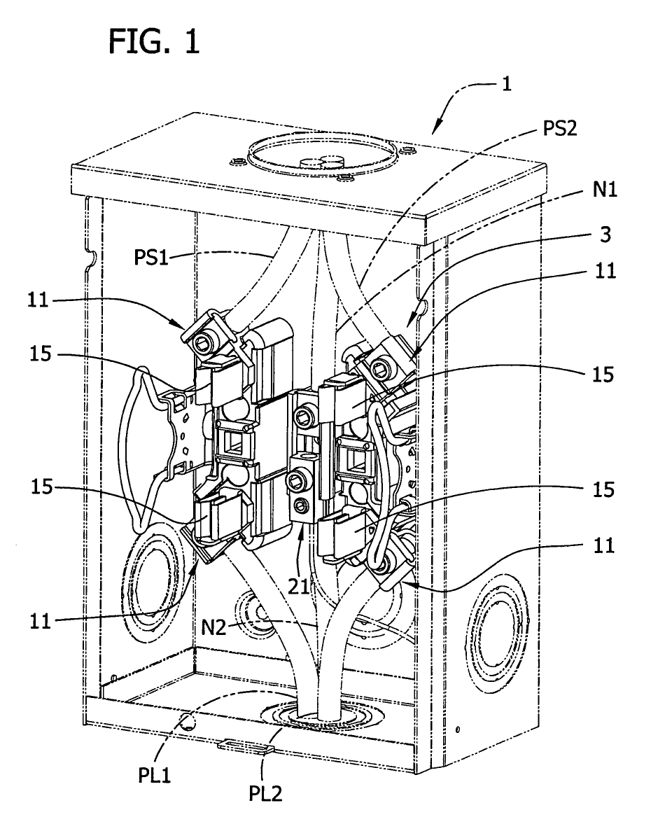

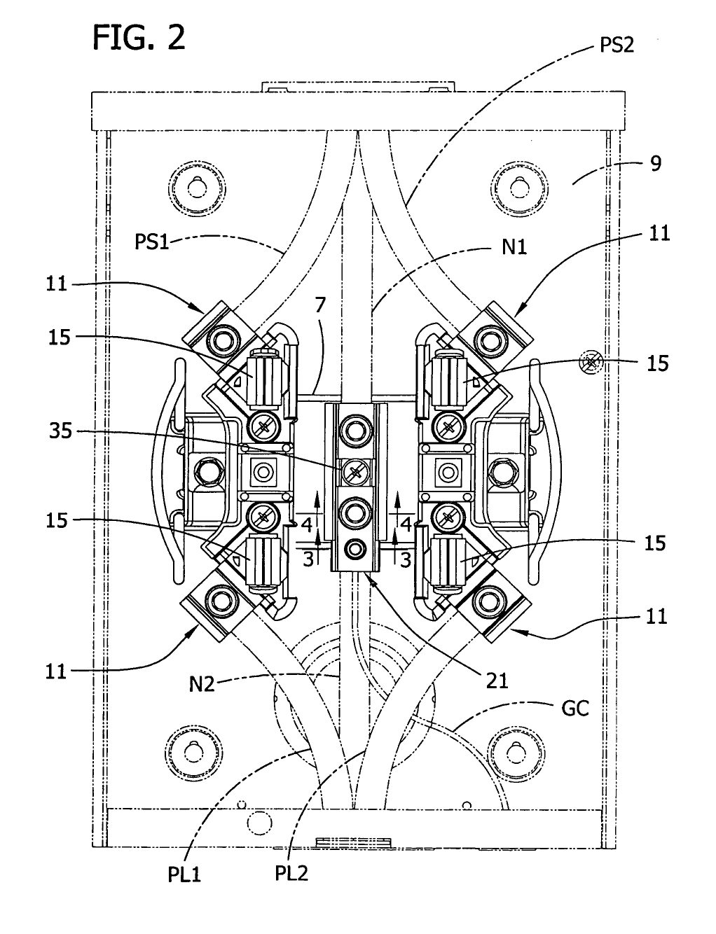

Referring now to the drawings, and to FIGS. 1 and 2 in particular, an enclosure for an electrical meter (not shown), sometimes referred to as a meter box, is generally designated 1. A meter socket assembly, generally designated 3, is mounted in the meter box and comprises a support 7 in the form of an inverted metal channel bolted to the back wall 9 of the box. A plurality of power line connector subassemblies 11 are secured to the support 7 for connecting electric power conductors of a power line system to the socket assembly 3. The installation shown in FIG. 1 is a single-phase, 3-wire power system found in most residential applications. The power system includes two power supply conductors PS1, PS2 which transmit power from a suitable power supply and are connected to two corresponding connector subassemblies 11, two power load conductors PL1, PL2 which transmit power to the residence and are connected to two corresponding connector subassemblies 11, and two neutral power conductors N1, N2. A plurality of socket connectors 15 are also mounted on the support 7 for receiving mating connectors of the electric meter. The power line connector subassemblies 11 and socket connectors 15 are of conventional design and thus are not described further.

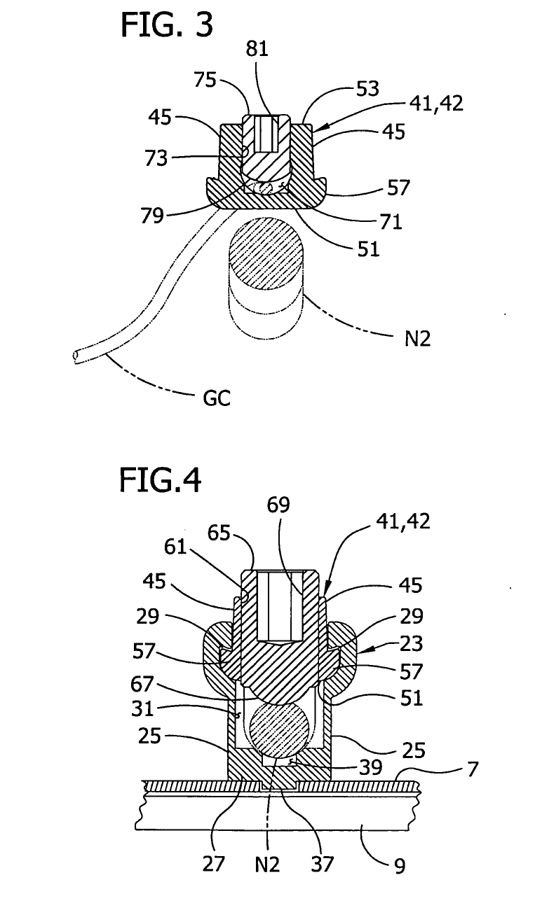

The socket assembly 3 also includes a neutral-ground connector subassembly, generally designated 21, mounted at a generally central location on the support 7. In the embodiment shown in FIGS. 1-6, the subassembly 21 includes a channel-shaped base, generally designated 23, having opposing legs 25 and a bottom 27 defining a saddle for supporting at least one and preferably both neutral conductors N1, N2 of the aforesaid power line system. In one embodiment, the opposing inside surfaces of the base 23 are generally parallel and the bottom 27 is arcuate, but other configurations are contemplated. A pair of opposing grooves 29 extend along the inside surfaces of the legs 25 adjacent the upper (free) ends of the legs. For reasons which will become apparent, the inside surfaces of the two legs 25 of the base 23 have opposing recesses 31 therein which extend from respective grooves 29 toward the bottom 27 of the base 23 and, in one embodiment, terminate at about the juncture between the legs and the bottom of the base.

The bottom 27 of the base 23 has a central opening 33 (FIG. 6) therein for receiving a fastener 35 (FIG. 2) to secure the base to the support 7 inside the meter box 1. A pair of bosses 37 (FIGS. 4 and 6) on the bottom of the base 23 are received in the support 7 to prevent rotation of the base relative to the support. The inside surface of the bottom 27 of the base 23 has a pair of depressions 39 therein (FIGS. 4 and 6) which are generally aligned with the bosses 37 and assist in providing a good electrical connection between the base and power conductors laid in the base, as will appear. The base 23 may be an elongate extruded part of a suitable metal (e.g., aluminum), or it may be fabricated in other ways.

The subassembly 21 also includes a neutral-ground connector, generally designated 41, comprising a body, generally designated 42, of electrically conductive material having opposite ends 43 and opposite sides 45. In the illustrated embodiment, the body 42 is generally rectangular but other shapes are contemplated. The sides 45 of the body 42 are slidably engageable with respective legs 25 of the base 23 to mount the connector on the base in a position in which a bottom face 51 of the body faces toward the bottom 27 of the base and a top face 53 of the body faces away from the bottom of the base. In one embodiment, the sides of the body 42 have tongues 57 slidably receivable in the grooves 29 in the legs 25 of the base 23. These connections are shown as being dovetail connections, but other types of tongue and groove connections, or different types of sliding connections, may be used.

A first screw opening 61 extends through the body 42 from the top face 53 of the body to the bottom face 51 of the body, and a first screw 65 threadable in the opening 61 to a position in which an end of the screw, preferably (but not necessarily) rounded as indicated at 67 in FIG. 4, is adapted to contact the neutral conductor N2 in the saddle of the base 23. The opposite end of the screw 65 has a socket 69 for receiving a tool (e.g., an Allen wrench) for tightening and loosening the screw. Other types of screws can be used. The screw 65 can be of an electrically conductive material or of a non-conductive material. The screw 65 is preferably sized so that when it is threaded through the opening 61 in the body 42, opposite side portions of the shank of the screw 65 are received in the recesses 31 in the inside surfaces of the legs 25 of the base 23. As a result, the connector 41 is held in substantially fixed position lengthwise of the base 23 and is prevented from slipping out of the base. Further, when the screw 65 is received in the recesses 31, the end 67 of the screw is advantageously aligned with one of the depressions 39 in the bottom 27 of the base 23 so that when the screw is tightened against the conductor N2, a portion of the conductor is deformed into the depression to assist in providing a good grip on the conductor and to ensure a good electrical connection between the base and the conductor.

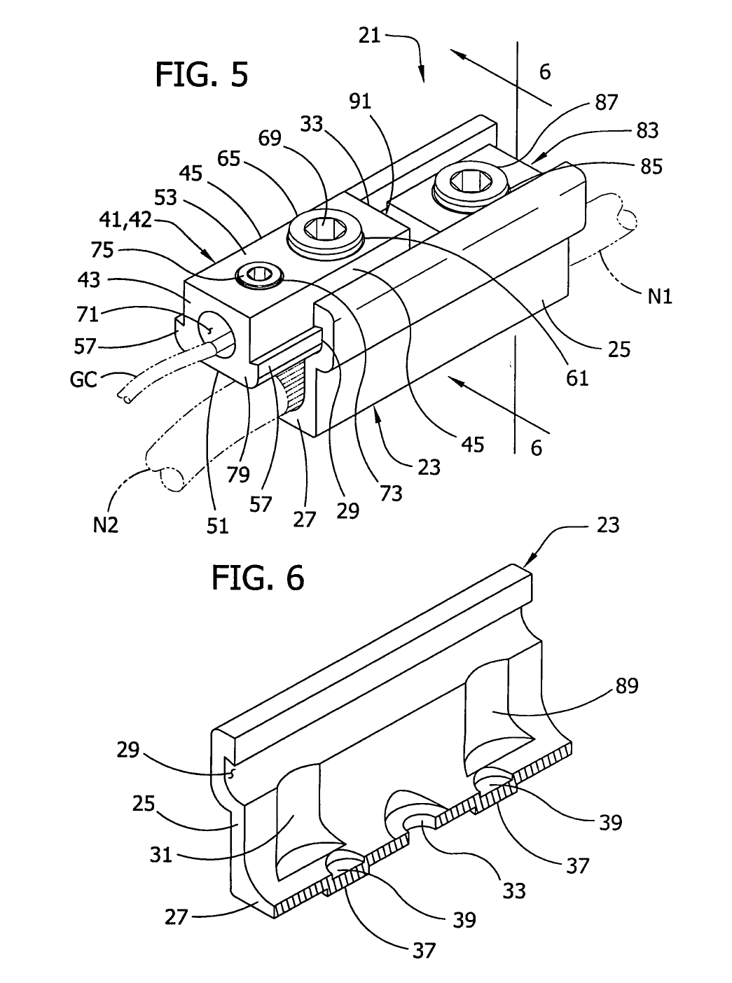

As shown in FIG. 5, a hole 71 is provided in the body 42 for receiving a ground conductor GC for grounding the socket assembly 3. A second screw opening 73 intersects the hole 71 in the body, and a second screw 75 of electrically conductive material is threadable in this opening 73 to a position in which it is adapted to contact the ground conductor GC in the hole 71. The second screw 75, like the first screw 65, preferably has a rounded end 79 for contacting the ground conductor and a socket 81 in its opposite end for receiving a suitable tool. Other types of screws can be used without departing from the scope of this invention. Although other configurations are possible, the ground conductor hole 71 of the illustrated embodiment extends from a first end 43 of the body inward into the body generally parallel to the top and bottom faces 53, 51 of the body, and the ground screw opening 73 extends from the top face of the body toward the bottom face of the body and intersects the hole 71. The illustrated ground screw 75 is smaller in diameter than the neutral screw 65 and has a diameter substantially equal to the diameter of the ground conductor hole 71 in the body 42. By way of example but not limitation, the neutral screw opening 61 may be a ¾ in. diameter opening tapped with 16 UNF-28 threads, and the ground screw hole 73 may be a 5/16 in. diameter opening tapped with 24 UNF-28 threads. Other variations are possible.

The illustrated connector subassembly 21 also includes a second connector, generally designated 83, slidable on the base 23. This second connector 83 is similar to the first connector 41 described above. It is generally rectangular in shape and has a screw opening 85 for receiving a screw 87 which may be threaded in the opening into contact with the neutral conductor N1 laid in the saddle of the base 23. The inner opposing surfaces of the legs 25 of the base 23 have recesses 89 similar to the recesses 31 described above. These recesses 89 are adapted to receive opposite side portions of the shank of the screw 87 to hold the connector 83 in fixed longitudinal position relative to the base 23 in a position in which the end of the screw 87 is aligned with one of the depressions 39 in the bottom 27 of the base 23. In the embodiment shown, the second connector 83 is also an extruded metal part (e.g., of aluminum), and the sides of the connector have tongues 91 slidably receivable in the grooves 29 in the legs 25 of the base 23. The connector 83 has no hole for receiving a ground conductor. Other variations are possible.

In use, the base 23 of the connector subassembly 21 is secured to the support 7 by one or more fasteners 35 extending through the bottom 27 of the base into the support. Alternatively, the base 23 can be secured at any other location in the meter box 1. For example, the base 23 can be secured to the back wall 9 of the meter box 1, or to a bus bar (not shown) in the meter box. After the base 23 is secured in place, the connectors 41, 83 are slidably mounted on the base 23 and the various conductors placed in respective positions, the two neutral conductors N1, N2 being inserted between the legs 25 of the base in the saddle of the base, and the grounding conductor GC being inserted into the grounding hole 71 in the neutral-ground connector 41. The neutral and grounding screws 65, 87, 75 are then tightened against respective conductors to provide good electrical connections between the power conductors and the base 23. All of these operations can be performed quickly, easily and safely using the unique neutral-ground subassembly 21 and neutral-ground connector 41 of this invention. The use of a single connector for connecting the neutral power conductors N1,N2 and the ground wire GC for the meter box 1 also saves considerable space compared to prior designs. The design of this invention is also very economical.

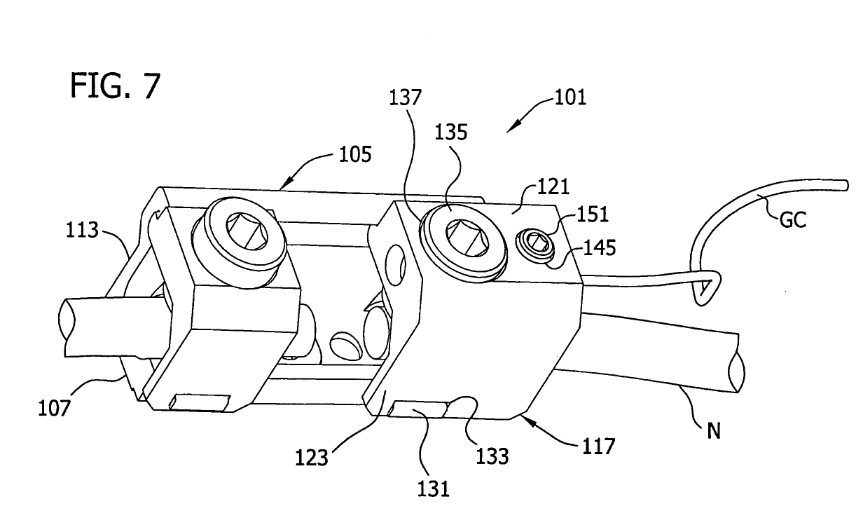

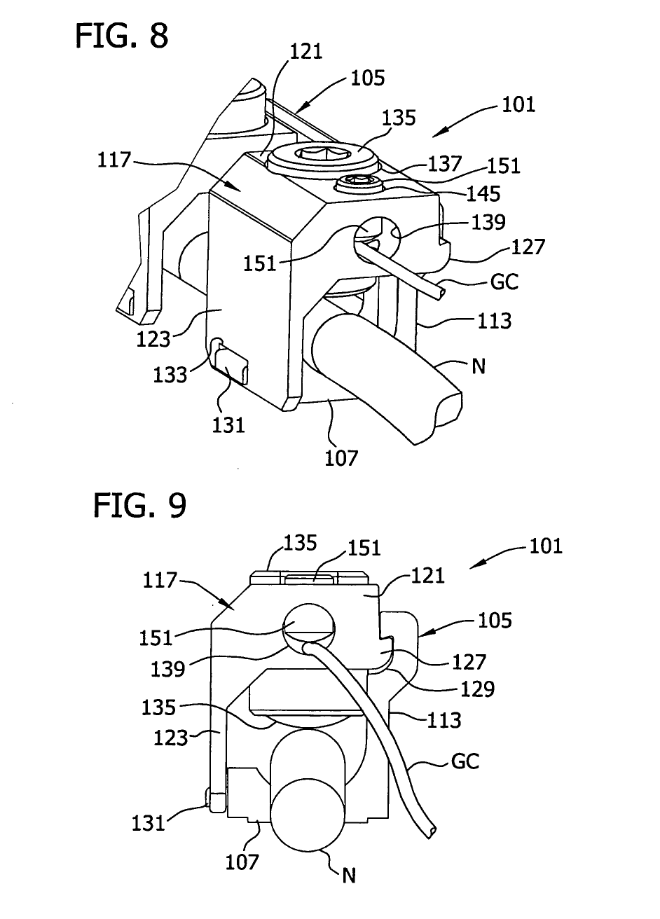

FIGS. 7-9 illustrate a second embodiment of a neutral-ground connector subassembly of this invention, generally designated 101. In this embodiment, the subassembly 101 comprises a generally L-shaped base, generally designated 105, having a bottom in the form of a first or lower generally horizontal leg 107 (as viewed in FIGS. 7-9) for supporting a neutral power conductor N, and a second or upper generally vertical leg 113 extending up from the bottom leg. The subassembly 101 also includes a connector comprising a generally L-shaped body, generally designated 117, having a first or upper generally horizontal leg 121 (as viewed in FIGS. 7-9) and a second or lower generally vertical leg 123 extending down from the upper leg. When assembled, the upper leg 121 of the connector body 117 is spaced above the bottom leg 107 of the base 105, and the lower vertical leg 123 of the body is spaced from the vertical leg 113 of the base, thus creating a cavity for accommodating the neutral conductor N. In the particular embodiment of FIG. 9, the upper leg 121 of the connector body 117 has sliding connection with the upper leg 113 of the base 105, as by a tongue 127 on the body 117 being slidable in a groove 129 in the base. A tab 131 on the base 105 received in an opening 133 in the lower leg 123 of the connector body 117 holds the body in a fixed longitudinal position relative to the base 105. Other types of connections between the body 117 and base 105 are possible.

In this embodiment, a first screw 135 is threaded down through a first tapped screw opening 137 in the upper leg 121 of the connector body 117 until it contacts the neutral conductor N to hold the conductor in place against the bottom leg 107 of the base 105. A hole 139 for receiving a meter box ground conductor GC extends from one end of the connector body 117 inward in a direction generally parallel to the upper leg 121 of the body. As illustrated in FIGS. 7 and 9, the hole 139 is disposed in the upper leg 121 of the connector body 117, but it will be understood that this location can vary. A second tapped screw opening 145 extends down through the connector body 117 and intersects the hole 139 receiving the meter box ground conductor GC. A second screw 151 is threaded in this opening 145 to contact the meter box ground conductor GC for securing it in place.

The construction of the bases 23,105 and neutral-ground connectors 41,117 described above may vary without departing from the scope of this invention. What is important is that the neutral-ground connector, whatever the shape, be configured for connecting the meter box grounding conductor GC in addition to at least one neutral conductor N1, N2 of the power circuit.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

1. A socket assembly for mounting an electric meter in a meter box, comprising
a plurality of power line connector subassemblies for connecting electric power conductors of a power line system to the socket assembly,
a plurality of socket connectors for receiving mating connectors of the electric meter, and
a neutral-ground connector subassembly comprising
a base having a bottom for supporting at least one neutral conductor of said power line system,
a neutral-ground connector comprising a body engageable with the base to mount the body on the base in a position in which a first face of the body faces toward the bottom of the base and a second face of the body opposite the first face faces away from the bottom of the base, a first screw opening through said body extending from the first face of the body to the second face of the body, a hole in the body for receiving a ground conductor of the socket assembly, and a second screw opening intersecting said hole in the body,
a first screw threadable in said first screw opening to a position in which the screw is adapted to contact said at least one neutral conductor on the bottom of the base, and
a second screw threadable in said second screw opening to a position in which the second screw is adapted to contact said ground conductor.

2. A socket assembly as set forth in claim 1 wherein said ground conductor hole in the body extends from a first end of the body inward into the body generally parallel to the first and second faces of the body, and wherein said second screw opening extends from the second face of the body toward the first face of the body and intersects said ground conductor hole.

3. A socket assembly as set forth in claim 1 wherein said base has opposing legs extending up from the bottom of the base, and wherein said body has opposite sides slidingly engageable with respective legs of the base.

4. A socket assembly as set forth in claim 3 wherein said opposite sides of the body have tongue and groove sliding connections with respective legs of the base.

5. A socket assembly as set forth in claim 1 wherein said second screw is smaller in diameter than said first screw.

6. A socket assembly as set forth in claim 1 wherein said second screw has a diameter substantially equal to the diameter of said ground conductor hole in the body.

7. A socket assembly as set forth in claim 1 wherein said base is an elongate extruded metal part generally U-shaped in transverse section, said base having opposing legs extending up from the bottom of the base, and the legs of the base have opposing inner surfaces formed with grooves.

8. A socket assembly as set forth in claim 7 wherein said body is an elongate extruded metal part, and wherein the body has opposite sides formed with tongues slidably receivable in the grooves in the legs of the base.

9. A socket assembly as set forth in claim 1 wherein said power line connector subassemblies, socket connectors and neutral-ground connector subassembly are mounted on a common support adapted to be installed in said meter box.

10. A socket assembly as set forth in claim 1 wherein said base is generally L-shaped and said connector body is generally L-shaped.

11. A socket assembly as set forth in claim 10 wherein said base has a first leg forming the bottom of the base and a second leg extending from the first leg, and wherein the connector body has a first leg spaced from and opposing the first leg of the base and a second leg spaced from and opposing the second leg of the base, said first and second legs of the base and the first and second legs of the connector body defining a cavity for receiving said neutral conductor.

12. A socket assembly as set forth in claim 11 wherein said second leg of the base has a sliding connection with the first leg of the connector body.

13. A socket assembly as set forth in claim 11 wherein said hole for receiving said ground conductor is located in the first leg of the connector body.

14. A neutral-ground body subassembly for use in a socket assembly for mounting an electric meter, said subassembly comprising
a base having a bottom for supporting at least one neutral conductor of a power line system,
a neutral-ground connector comprising a body of electrically conductive material engageable with the base to mount the body on the base in a position in which a first face of the body faces toward the bottom of the base and a second face of the body opposite the first face faces away from the bottom of the base, a first screw opening through said body extending from the first face of the body to the second face of the body, a hole in the body for receiving a ground conductor of the socket assembly, and a second screw opening intersecting said hole in the body,
a first screw threadable in said first screw opening to a position in which the screw is adapted to contact said at least one neutral conductor on the bottom of the base, and
a second screw threadable in said second screw opening to a position in which the second screw is adapted to contact said ground conductor.

15. A subassembly as set forth in claim 14 wherein said ground conductor hole in the body extends from a first end of the body inward into the body generally parallel to the first and second faces of the body, and wherein said second screw opening extends from the second face of the body toward the first face of the body and intersects said ground conductor hole.

16. A subassembly as set forth in claim 14 wherein said base has opposing legs extending up from the bottom of the base, and wherein said body has opposite sides slidingly engageable with respective legs of the base.

17. A subassembly as set forth in claim 16 wherein said opposite sides of the body have tongue and groove sliding connections with respective legs of the base.

18. A subassembly as set forth in claim 14 wherein said second screw is smaller in diameter than said first screw.

19. A subassembly as set forth in claim 14 wherein said second screw has a diameter substantially equal to the diameter of said ground conductor hole in the body.

20. A subassembly as set forth in claim 14 wherein said base is an elongate extruded metal part generally U-shaped in transverse section, said base having opposing legs extending from the bottom of the base, said the legs of the base having opposing inner surfaces formed with grooves.

21. A subassembly as set forth in claim 20 wherein said body is an elongate extruded metal part, and wherein the body has sides formed with tongues slidably receivable in the grooves in the legs of the base.

22. A socket assembly as set forth in claim 14 wherein said base is generally L-shaped and said connector body is generally L-shaped.

23. A socket assembly as set forth in claim 22 wherein said base has a first leg forming the bottom of the base and a second leg extending from the first leg, and wherein the connector body has a first leg spaced from and opposing the first leg of the base and a second leg spaced from and opposing the second leg of the base, said first and second legs of the base and the first and second legs of the connector body defining a cavity for receiving said neutral conductor.

24. A socket assembly as set forth in claim 23 wherein said second leg of the base has a sliding connection with the first leg of the connector body.

25. A socket assembly as set forth in claim 23 wherein said hole for receiving said ground conductor is located in the first leg of the connector body.

26. A neutral-ground connector for use in a socket assembly for mounting an electric meter, said socket assembly including a base having a bottom for supporting at least one neutral conductor of a power line system, said connector comprising
a body of electrically conductive material configured for engagement with the base to mount the body on the base in a position in which a first face of the body faces toward the bottom of the base and a second face opposite the first face faces away from the bottom of the base,
a first screw opening through said body extending from the first face of the body to the second face of the body,
a hole in the body for receiving a ground conductor of the socket assembly,
a second screw opening intersecting said hole in the body,
a first screw threadable in said first screw opening to a position in which the screw is adapted to contact said at least one neutral conductor on the bottom of the base, and
a second screw threadable in said second screw opening to a position in which the second screw is adapted to contact said ground conductor.

27. A connector as set forth in claim 26 wherein said hole in the body extends from a first end of the body inward into the body generally parallel to the first and second faces of the body, and wherein said second screw opening extends from the second face of the body toward the first face of the body and intersects said ground conductor hole.

28. A connector as set forth in claim 26 wherein said base has opposing legs extending up from the bottom of the base, and wherein said body has opposite sides slidingly engageable with respective legs of the base.

29. A connector as set forth in claim 28 wherein said opposite sides of the body are configured to have tongue and groove sliding connections with respective legs of the base.

30. A connector as set forth in claim 26 wherein said second screw is smaller in diameter than said first screw.

31. A connector as set forth in claim 26 wherein said second screw has a diameter substantially equal to the diameter of said ground conductor hole in the body.

32. A socket assembly as set forth in claim 26 wherein said base is generally L-shaped and said connector body is generally L-shaped.

33. A socket assembly as set forth in claim 32 wherein said base has a first leg forming the bottom of the base and a second leg extending from the first leg, and wherein the connector body has a first leg spaced from and opposing the first leg of the base and a second leg spaced from and opposing the second leg of the base, said first and second legs of the base and the first and second legs of the connector body defining a cavity for receiving said neutral conductor.

34. A socket assembly as set forth in claim 33 wherein said second leg of the base has a sliding connection with the first leg of the connector body.

35. A socket assembly as set forth in claim 33 wherein said hole for receiving said ground conductor is located in the first leg of the connector body.

36. A socket assembly for mounting an electric meter in a meter box, comprising
a plurality of power line connector subassemblies for connecting electric power conductors of a power line system to the socket assembly,
a plurality of socket connectors for receiving mating connectors of the electric meter, and
a neutral-ground connector subassembly comprising
a base having a bottom for supporting at least one neutral conductor of said power line system,
a neutral-ground connector comprising a body engageable with the base to mount the body on the base in a position in which a first substantially planar face of the body faces toward the bottom of the base and a second substantially planar face of the body opposite the first face faces away from the bottom of the base, a first screw opening through said body extending from the first face of the body to the second face of the body, a hole in the body for receiving a ground conductor of the socket assembly, and a second screw opening intersecting said hole in the body, said hole in the body being disposed between said second face of the body and the bottom of the base when the body is mounted on the base,
a first screw threadable in said first screw opening to a position in which the screw is adapted to contact said at least one neutral conductor on the bottom of the base, and
a second screw threadable in said second screw opening to a position in which the second screw is adapted to contact said ground conductor.

37. A socket assembly as set forth in claim 36 wherein said body is extruded and of a one-piece construction.

38. A socket assembly as set forth in claim 37 wherein said body is elongate and has a substantially uniform cross-sectional shape along an entire length of the body.

39. A socket assembly for mounting an electric meter in a meter box, comprising
a plurality of power line connector subassemblies for connecting electric power conductors of a power line system to the socket assembly,
a plurality of socket connectors for receiving mating connectors of the electric meter, and
a neutral-ground connector subassembly comprising
a base having a bottom for supporting at least one neutral conductor of said power line system,
a neutral-ground connector comprising an extruded, one-piece body engageable with the base to mount the body on the base in a position in which a first face of the body faces toward the bottom of the base and a second face of the body opposite the first face faces away from the bottom of the base, a first screw opening through said body extending from the first face of the body to the second face of the body, a hole in the body for receiving a ground conductor of the socket assembly, and a second screw opening intersecting said hole in the body,
a first screw threadable in said first screw opening to a position in which the screw is adapted to contact said at least one neutral conductor on the bottom of the base, and
a second screw threadable in said second screw opening to a position in which the second screw is adapted to contact said ground conductor.

40. A socket assembly as set forth in claim 39 wherein said body is elongate and has a substantially uniform cross-sectional shape along an entire length of the body.

41. A socket assembly as set forth in claim 40 wherein said first face and said second face are substantially planar and said hole in the body is disposed between said second face of the body and the bottom of the base when the body is mounted on the base.
